(19) United States
(12) Patent Application Publication
(10) Pub. No.: US 2026/0253963 A1
(43) Pub. Date: Aug. 27, 2026

(54) METHOD OF PREPARING A NEGATIVE ELECTRODE, AND RECHARGEABLE LITHIUM BATTERY INCLUDING THE SAME

(71) Applicants: SAMSUNG SDI CO., LTD., Yongin-si (KR); G.L.CHEM CO., LTD., Hwaseong-si (KR)

(72) Inventors: Minho CHO, Yongin-si (KR); Hana KIM, Yongin-si (KR); Jonggil SHIM, Cheongju-si (KR); Dongseok RYU, Cheongju-si (KR); Byoungseob LEE, Cheongju-si (KR)

(73) Assignees: SAMSUNG SDI CO., LTD., Yongin-si, Gyeonggi-do (KR); G.L.CHEM CO., LTD., Hwaseong-si, Gyeonggi-do (KR)

(21) Appl. No.: 19/541,713

(22) Filed: Feb. 17, 2026

(30) Foreign Application Priority Data
Feb. 27, 2025 (KR) 10-2025-0026151

(51) Int. Cl. H01M 10/0569; H01M 4/505; H01M 10/0525; H01M 10/0567

(52) U.S. Cl. CPC H01M 10/0569; H01M 4/505; H01M 10/0525; H01M 10/0567

(57) ABSTRACT

Disclosed are a carboxylmethyl cellulose lithium salt, a method of preparing the carboxylmethyl cellulose lithium salt, and a negative electrode and a rechargeable lithium battery including the carboxylmethyl cellulose lithium salt. The method for preparing carboxymethyl cellulose lithium salt includes reacting carboxymethyl cellulose sodium salt and sulfuric acid to produce carboxymethyl cellulose, and reacting the carboxymethyl cellulose and lithium hydroxide to produce carboxymethyl cellulose lithium salt. During the production of the carboxymethyl cellulose, about 50 parts to about 200 parts by weight of the sulfuric acid is reacted based on 100 parts by weight of the carboxymethyl cellulose sodium salt.

### CROSS-REFERENCE TO RELATED APPLICATION

This application claims priority to Korean Patent Application No. 10-2025-0026151 filed with the Korean Intellectual Property Office on Feb. 27, 2025, the entire contents of which are incorporated herein by reference.

### BACKGROUND

### 1. Field

The present disclosure relates to a carboxylmethyl cellulose lithium salt, a method of preparing carboxylmethyl cellulose lithium salt, a negative electrode, and a rechargeable lithium battery.

### 2. Description of the Related Art

With increasing use of electronic devices that use batteries, such as, e.g., mobile phones, laptop computers, and electric vehicles, the demand for small, lightweight, and relatively high-capacity rechargeable batteries is increasing. In particular, rechargeable lithium batteries are attracting attention as a power source for portable devices because they are lightweight and have high energy density. Accordingly improving the performance of rechargeable lithium batteries may be advantageous.

Carboxymethyl cellulose is a type of thickener and is a key material that may be used in the negative electrode and separator of rechargeable lithium batteries. The carboxymethyl cellulose is mainly used in the form of a salt substituted with sodium to ensure water solubility in the process, and Herein, sodium may cause an electrochemical side reaction in a rechargeable lithium battery. Accordingly, using carboxymethyl cellulose substituted with lithium instead of sodium may be advantageous.

However, in the process of producing carboxymethyl cellulose lithium salt from carboxymethyl cellulose sodium salt, a decomposition reaction is promoted, and a carboxymethyl cellulose lithium salt having a lower viscosity than the starting material, carboxymethyl cellulose sodium salt, is produced.

If (when) a carboxymethyl cellulose lithium salt having a low viscosity is used, problems such as reduced negative electrode slurry stability and reduced negative electrode adhesion may occur. In order to increase the viscosity of carboxymethyl cellulose lithium salt, there is a method of greatly increasing the viscosity of the starting material, carboxymethyl cellulose sodium salt, but this may cause issues such as poor preparing processability and increased material costs.

### SUMMARY

Some example embodiments include a method for minimizing decomposition reactions in the process of preparing a carboxymethyl cellulose lithium salt from a carboxymethyl cellulose sodium salt.

Some example embodiments include a method for preparing carboxymethyl cellulose lithium salt, the method including reacting carboxymethyl cellulose sodium salt and sulfuric acid to produce carboxymethyl cellulose, and reacting the carboxymethyl cellulose and lithium hydroxide to produce carboxymethyl cellulose lithium salt. During the production of the carboxymethyl cellulose, about 50 parts to about 200 parts by weight of the sulfuric acid is reacted based on 100 parts by weight of the carboxymethyl cellulose sodium salt.

The preparing method of some example embodiments may include the carboxymethyl cellulose lithium salt having a similar viscosity to the viscosity of the starting material, carboxymethyl cellulose sodium salt, by minimizing the decomposition reaction during the process of preparing the carboxymethyl cellulose lithium salt from the carboxymethyl cellulose sodium salt.

### BRIEF DESCRIPTION OF THE DRAWINGS

FIG. 1 to FIG. 4 are schematic drawings illustrating rechargeable lithium batteries according to some example embodiments.

FIG. 5 is a flow chart illustrating a method of preparing carboxymethyl cellulose lithium salt, according to example embodiments.

### DETAILED DESCRIPTION

Hereinafter, example embodiments of the present disclosure are described in detail. However, these embodiments are examples, the present disclosure is not limited thereto, and the present disclosure is defined by the scope of claims.

“Combination of these” refers to a mixture, laminate, composite, copolymer, alloy, blend, reaction product, and the like, of the constituents.

It should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

Throughout this specification, whenever it is said that a part “includes” a component, this does not exclude other components, but rather includes other components, unless otherwise specifically stated.

In addition, the terms “about,” “substantially,” and the like, used throughout the specification of this application, are used in the sense that they are numerical or close to numerical values when manufacturing and material tolerances inherent in the meanings stated are presented. For example, when the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

Throughout this specification, references to “A and/or B” mean “A or B or both.”

As used herein, when a definition is not otherwise provided, the particle diameter means an average particle diameter (D50), which is a diameter of particles with a cumulative volume of 50 volume % in the particle size distribution. The average particle diameter (D50) can be measured by methods known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle diameter (D50) value may be readily obtained through a calculation.

### Method of Preparing Carboxylmethyl Cellulose Lithium Salt

Some example embodiments include a method for preparing carboxymethyl cellulose lithium salt which includes reacting carboxymethyl cellulose sodium salt and sulfuric acid to produce carboxymethyl cellulose, and reacting the carboxymethyl cellulose and lithium hydroxide to produce carboxymethyl cellulose lithium salt. During the production of the carboxymethyl cellulose, about 50 parts to about 200 parts by weight of the sulfuric acid is reacted based on 100 parts by weight of the carboxymethyl cellulose sodium salt.

(1) The preparing method of some example embodiments is a simple but efficient process of preparing carboxymethyl cellulose by reacting carboxymethyl cellulose sodium salt with an aqueous sulfuric acid solution, and then replacing sodium with lithium.

Herein, when using another acid such as, e.g., hydrochloric acid instead of sulfuric acid, the lithium substitution reaction proceeds at a high temperature of about 60° C. or higher, making it challenging to reduce or suppress the hydrolysis reaction of carboxymethyl cellulose sodium salt.

(2) In the preparing method of some example embodiments, the decomposition reaction of the carboxymethyl cellulose sodium salt may be minimized by controlling a weight of the sulfuric acid reacted with the carboxymethyl cellulose sodium salt, which is the starting material.

As a result, a carboxymethyl cellulose lithium salt having a similar viscosity to the viscosity of the starting material, carboxymethyl cellulose sodium salt, may be produced.

(3) In the preparing method of some example embodiments, about 50 parts to about 200 parts by weight of the sulfuric acid is reacted based on 100 parts by weight of the carboxymethyl cellulose sodium salt.

If (when) less than about 50 parts by weight of sulfuric acid is used based on 100 parts by weight of the carboxymethyl cellulose sodium salt, the reactivity may decrease during the process of preparing carboxymethyl cellulose lithium salt from carboxymethyl cellulose sodium salt, and the amount of unreacted carboxymethyl cellulose sodium salt may increase. Meanwhile, when sulfuric acid is used in an amount exceeding about 200 parts by weight based on 100 parts by weight of carboxymethyl cellulose sodium salt, the decomposition reaction is significantly accelerated, and carboxymethyl cellulose lithium salt that does not satisfy Equation 1 may be prepared.

Hereinafter, a method for preparing carboxymethyl cellulose lithium salt according to some example embodiments is described in more detail.

### Viscosities of Starting Material Dilution Solution and Final Material Dilution Solution

As mentioned above, while the prior art produces carboxymethyl cellulose lithium salt having a lower viscosity than the starting material, carboxymethyl cellulose sodium salt, in some example embodiments, a carboxymethyl cellulose lithium salt having a similar viscosity to the viscosity of the starting material, carboxymethyl cellulose sodium salt, may be produced.

For example, the starting material, carboxymethyl cellulose sodium salt, and the final material, carboxymethyl cellulose lithium salt, may satisfy Equation 1:

$$0.8 < {V}_{2} / {V}_{1} \leq 1.2 . \qquad Equation 1$$

In Equation 1, V₁ is a viscosity of an aqueous solution of carboxymethyl cellulose sodium salt including about 1 wt % of the carboxymethyl cellulose sodium salt (starting material dilution solution) at a temperature of about 25° C.; and V₂ is a viscosity of an aqueous solution of carboxymethyl cellulose lithium salt containing about 1 wt % of the carboxymethyl cellulose lithium salt (final material dilution solution) at a temperature of about 25° C.

The lower limit of Equation 1 may be greater than about 0.8, greater than or equal to about 0.85, greater than or equal to about 0.9, or greater than or equal to about 0.94, and the upper limit may be less than or equal to about 1.2, less than or equal to about 1, less than or equal to about 0.99, less than or equal to about 0.98, or less than or equal to about 0.97.

V₁ may be in a range of about 1,000 cps to about 5,000 cps, or about 2,900 cps to about 3,000 cps; V₂ may be in a range of about 1,000 cps to about 5,000 cps, or about 2,700 cps to about 2,900 cps.

### Reaction Temperature

The reaction of the carboxymethyl cellulose sodium salt and sulfuric acid; and the reaction of the carboxymethyl cellulose and lithium hydroxide may each be carried out at a temperature in a range of about 20° C. to about 30° C.

### Preparing of Carboxymethyl Cellulose

When reacting the carboxymethyl cellulose sodium salt and sulfuric acid, about 50 parts to about 200 parts by weight of the sulfuric acid may be reacted based on 100 parts by weight of the carboxymethyl cellulose sodium salt.

For example, the sulfuric acid may be in the form of an aqueous sulfuric acid solution, and the aqueous sulfuric acid solution may include about 90 to about 99 wt % sulfuric acid.

In addition, when reacting the carboxymethyl cellulose sodium salt and sulfuric acid, the carboxymethyl cellulose sodium salt may be in a dispersed state in a mixed solvent of ethanol and water.

For example, the mixed solvent may include about 80 wt % to about 99 wt % of ethanol and about 1 wt % to about 20 wt % of water; and about 800 wt % to about 2,200 wt % of the mixed solvent may be used based on 100 wt % of the carboxymethyl cellulose sodium salt.

### Preparing of Carboxymethyl Cellulose Lithium Salt

When reacting the above carboxymethyl cellulose and lithium hydroxide, about 10 parts by weight to about 100 parts by weight, about 15 parts by weight to about 50 parts by weight, or about 20 parts by weight to about 40 parts by weight of the lithium hydroxide may be reacted based on 100 parts by weight of the carboxymethyl cellulose.

When reacting the carboxymethyl cellulose and lithium hydroxide, the carboxymethyl cellulose may be used in a dispersed state in a mixed solvent of ethanol and water.

For example, the mixed solvent may include about 80 wt % to about 99 wt % of ethanol and about 1 wt % to about 20 wt % of water; and about 800 wt % to about 2,200 wt % of the mixed solvent may be used based on 100 wt % of the carboxymethyl cellulose.

### Carboxymethyl Cellulose Lithium Salt

Some example embodiments include a carboxymethyl cellulose lithium salt prepared by the method of the above-described embodiment.

### Number of Microgels

The number of microgels in a film including a carboxymethyl cellulose lithium salt of some example embodiments may be equal to 0, or may be greater than 0 and less than or equal to about 50, less than or equal to about 40, or less than or equal to about 30. Within the above ranges, the smaller the number of microgels, the better the coating uniformity of the negative electrode plate.

On the contrary, if (when) out of the above ranges, the coating uniformity of a negative electrode plate manufactured by applying the carboxylmethyl cellulose lithium salt as a negative electrode binder may be deteriorated.

### Degree of Lithium Substitution

The carboxylmethyl cellulose lithium salt may have three or fewer —CH₂COOLi-type substituents per cellulose repeating unit, that is, one unit. In this regard, the carboxylmethyl cellulose lithium salt may have a degree of lithium substitution (a degree of substitution, DS) in the range of about 0.70 to about 1.30, about 0.80 to about 1.20, or about 0.90 to about 1.10.

Herein ‘degree of lithium substitution’ may be measured in the following titrimetric method.
1) About 150 ml of 80% ethanol is added to a 250 ml beaker.
2) About 10 ml of 70% HNO₃ is added to the beaker by using a pipette.
3) About 1 g to 2 g of a carboxymethyl cellulose (CMC) sample is added thereto, and then stirred with a magnetic stirrer for about 1 hour.
4) After allowing the beaker to stand for about 10 minutes to about 20 minutes to settle precipitates, a supernatant is discarded
(Supernatant: Solution Present on Top of the CMC Precipitates).
5) About 150 ml of 80% ethanol is added again thereto and then, stirred for about 30 minutes to about 40 minutes.
6) After allowing the beaker for about 10 minutes to about 20 minutes, a supernatant is discarded.
7) While filtering the residue with an aspirator, a filtrate therefrom is washed by slowly adding about 500 ml of 80% ethanol dropwise. In the last step, a product therefrom is 1 to 2 times washed with 95% ethanol.
8) Because the sample on the wall of the filter is highly likely be contaminated with acid like CMC-acid, the center portion thereof is taken and placed in a clean watch plate.
9) Drying in a dry oven at about 70° C. for about 20 minutes, and then cooling at room temperature for about 15 minutes to about 20 minutes are performed.
10) About 100 ml of distilled water is added to a 250 ml beaker, and about 25 ml of 0.1 N NaOH is added thereto with a pipette.
11) The sample is weighed by about 0.2 g without any loss and moisture absorption of the sample, and then slowly added to the beaker (0.2 g±0.05).
12) CMC is dissolved by using a magnetic stirrer until the CMC becomes transparent (about 40 minutes to about 60 minutes).
13) When the sample is completely, or substantially completely, dissolved, about 1% phenolphthalein is added thereto by 2 to 3 drops.
14) While continuously stirring, titration with 0.1 N H₂SO₄ is performed.
15) When the titration is completed, the solution is changed from red to transparent, at which how much 0.1 N H₂SO₄ is used is recorded.
16) The Degree of Substitution (D.S) value is calculated according to Equations 1 and 2.

$$Equation 1$$

$$A = ( CMC - mmole number of acid ) / ( weight ( g ) of dried sample ) = CMC Acid mmole number per 1 g of dried sample .$$

$$Equation 2$$

$$B ( D . S ) value ) = ( 16 \; 2 \times A ) / ( 10 , 000 - 58 \times A ) = ( 162 \times ( NaOH amount - {H}_{2} {SO}_{4} consumption ) \div weight ( g ) of dried sample ) / ( 10 , 000 - 58 \times ( NaOH amount - {H}_{2} {SO}_{4} consumption ) \div weight ( g ) of dried sample ) .$$

### Weight Average Molecular Weight

The carboxylmethyl cellulose lithium salt has an average molecular weight (Mw) in a range of about 10,000 g/mol to about 5,000,000 g/mol, or about 100,000 g/mol to about 3,000,000 g/mol. If (when) the carboxylmethyl cellulose lithium salt has an average molecular weight (Mw) within the above ranges, a slurry type composition for manufacturing a negative electrode may have appropriate viscosity, which may improve processability.

### Negative Electrode and Rechargeable Lithium Battery

Some example embodiments include a negative electrode for a rechargeable lithium battery, which includes a current collector and a negative electrode active material layer on the current collector, wherein the negative electrode active material layer includes the carboxymethyl cellulose lithium salt of the above-described example embodiment.

The carboxymethyl cellulose lithium salt is a type of thickener and may be included in an amount in a range of about 0.5 wt % to about 3 wt % based on 100 wt % of the total negative electrode active material layer.

Some example embodiments include a rechargeable lithium battery including the negative electrode of the above-described embodiment; a positive electrode; and an electrolyte.

When the carboxymethyl cellulose lithium salt of the above-described embodiment is used, a suitable viscosity can be exhibited and processability can be exhibited when preparing a slurry type composition for manufacturing a negative electrode. Accordingly, a rechargeable lithium battery of some example embodiments may be manufactured by an efficient process.

Hereinafter, redundant descriptions of the negative electrode and the rechargeable lithium battery are omitted, and other configurations are described in detail.

### Negative Electrode Active Material

The negative electrode active material may be or include at least one of a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon or a combination thereof. The crystalline carbon may be or include graphite such as non-shaped, plate-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy may include lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x<2), a Si-Ω alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to some example embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery includes a current collector, and a negative electrode active material layer on the current collector. The negative electrode active material layer includes a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

According to some example embodiments, a carboxymethyl cellulose lithium salt may be included in the negative electrode active material layer. In this case, the carboxymethyl cellulose lithium salt may be included in an amount in a range of about 0.5 wt % to about 3 wt % based on 100 wt % of a total negative electrode active material layer.

The binder may attach the negative electrode active material particles to each other, and may attach the negative electrode active material to the current collector. The binder may include a non-aqueous binder, an aqueous binder, a dry binder, or a combination thereof.

The non-aqueous binder may at least one of include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, the aqueous binder may further include a cellulose-based compound capable of imparting viscosity. The cellulose-based compound includes one or more of carboxylmethyl cellulose, hydroxypropylmethyl cellulose, methyl cellulose, or alkali metal salts thereof. The alkali metal may be or include at least one of Na, K, or Li.

The dry binder may be or include a polymer material capable of being fiberized, and may be or include, for example, at least one of polytetrafluoroethylene, polyvinylidene fluoride, polyvinylidene fluoride-hexafluoropropylene copolymer, polyethylene oxide, or a combination thereof.

The conductive material is included to provide electrode conductivity, and any electrically conductive material may be used as a conductive material unless the electrically conductive material causes an adverse chemical change. Examples of the conductive material may be or include a carbon-based material such as at least one of natural graphite, artificial graphite, carbon black, acetylene black, Ketjen black, a carbon fiber, a carbon nanofiber, a carbon nanotube, and the like; a metal-based material such as at least one of copper, nickel, aluminum silver, and the like in a form of a metal powder or a metal fiber; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof, but is not limited thereto.

### Positive Electrode Active Material

The positive electrode active material may be or include a compound (lithiated intercalation compound) capable of intercalating and deintercalating lithium. For example, one or more types of composite oxides of lithium and a metal such as or including at least one of cobalt, manganese, nickel, and combinations thereof may be used.

The composite oxide may be or include a lithium transition metal composite oxide, and examples thereof may include at least one of lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following Chemical Formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, at least one of a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

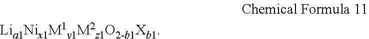

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² independently are or include one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

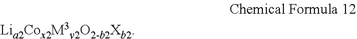

In Chemical Formula 12, 0.9≤a2≤1.8, 0.7≤x2≤1, 0≤y2≤0.3, 0.9≤x2+y2≤1.1, and 0≤b2≤0.1, M³ is or includes one or more of Al, B, Ba, Ca, Ce, Cr, Cu, Fe, Mg, Mn, Mo, Ni, Se, Si, Sn, Sr, Ti, V, W, Y, Zn and Zr, and X is or includes one or more of F, P, and S.

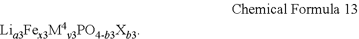

In Chemical Formula 13, 0.9≤a3≤1.8, 0.6≤x3≤1, 0≤y3≤0.4, and 0≤b3≤0.1, M⁴ is or includes one or more of Al, B, Ba, Ca, Ce, Co, Cr, Cu, Mg, Mn, Mo, Ni, Se, Si, Sn, Sr, Ti, V, W, Y, Zn and Zr, and X is or includes one or more of F, P, and S.

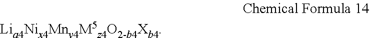

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1, M⁵ is or includes one or more of Al, B, Ba, Ca, Ce, Cr, Fe, Mg, Mo, Nb, Si, Sn, Sr, Ti, V, W, and Zr, and X is or includes one or more of F, P, and S.

As an example, the positive electrode active material may be or include a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel-based positive electrode active materials can achieve high capacity, and can be applied to a high-capacity, high-density rechargeable lithium battery.

### Positive Electrode

The positive electrode for a rechargeable lithium battery may include a current collector, and a positive electrode active material layer on the current collector. The positive electrode active material layer may include a positive electrode active material, and may further include a binder and/or a conductive material.

For example, the positive electrode may further include an additive that can constitute a sacrificial positive electrode.

An amount of the positive electrode active material may be in a range of about 90 wt % to about 99.5 wt %, and an amount of the binder and the conductive material may be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may impart conductivity (e.g., electrical conductivity) to the electrode. Any material that does not cause chemical change (e.g., does not cause an undesirable chemical change in the rechargeable lithium battery), and that conducts electrons, may be used in the battery. Examples of the conductive material may include a carbon-based material such as at least one of natural graphite, artificial graphite, carbon black, acetylene black, Ketjen black, a carbon fiber, a carbon nanofiber, and carbon nanotube; a metal-based material including copper, nickel, aluminum, silver, and the like, in the form of a metal powder or a metal fiber; a conductive polymer such as a polyphenylene derivative; or a mixture thereof.

The current collector may include Al, but is not limited thereto.

### Electrolyte Solution

The electrolyte may be or include a solid electrolyte or a liquid electrolyte (i.e., an electrolyte solution).

The electrolyte solution for a rechargeable lithium battery includes a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, alcohol-based solvent, aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone. The alcohol-based solvent may include ethyl alcohol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, and the like.

The non-aqueous organic solvent may be used alone, or in combination of two or more solvents.

Additionally, when using a carbonate-based solvent, cyclic carbonate and chain carbonate can be mixed, and cyclic carbonate and chain carbonate may be mixed at a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of a lithium salt may include one, or more than one, of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (x and y are integers in a range from 1 to 20), lithium trifluoromethane sulfonate, lithium tetrafluoroethanesulfonate, lithium difluorobis(oxalato)phosphate (LiDFOB), and lithium bis(oxalato)borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as two-layer a polyethylene/polypropylene separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces of the porous substrate.

The porous substrate may be or include a polymer film formed of or including at least one of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), and polytetrafluoroethylene.

The organic material may include a polyvinylidene fluoride-based polymer or a (meth)acrylic polymer.

The inorganic material may include inorganic particles such as at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

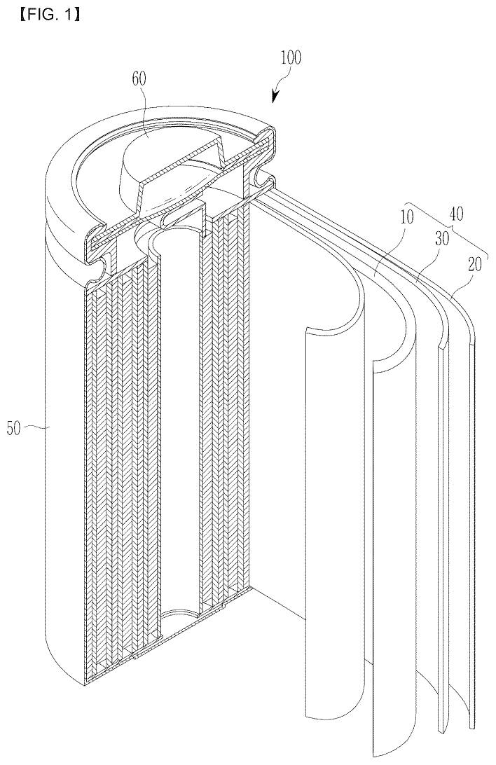

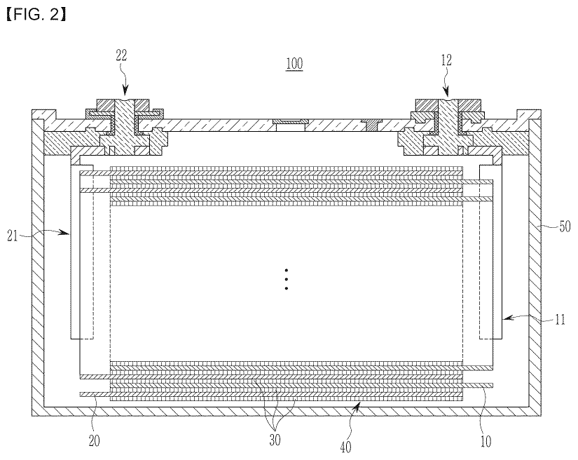

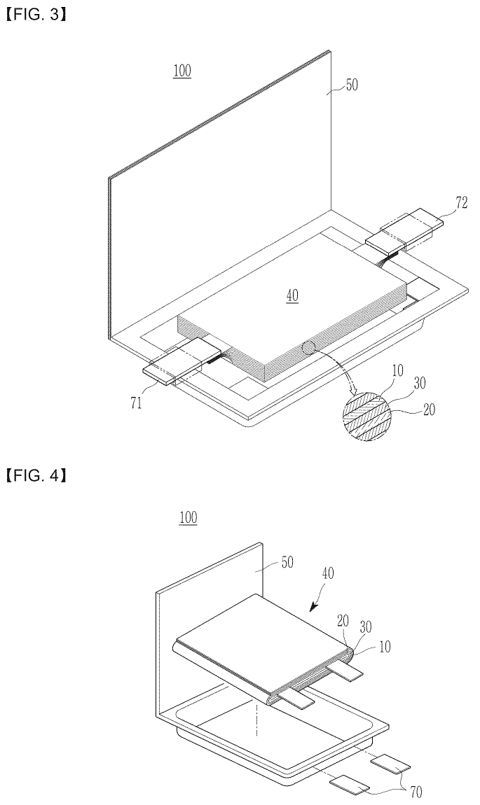

The rechargeable lithium battery may be classified into cylindrical, prismatic, pouch, or coin-type batteries, and the like depending on the shape thereof. FIG. 1 to FIG. 4 are schematic views illustrating a rechargeable lithium battery according to some example embodiments. FIG. 1 shows a cylindrical battery, FIG. 2 shows a prismatic battery, and FIG. 3 and FIG. 4 show pouch-type batteries. Referring to FIG. 1 to FIG. 4, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 sealing the case 50 as shown in FIG. 1. In addition, in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 3 and FIG. 4, the rechargeable lithium battery 100 includes an electrode tab 70 illustrated in FIG. 4, of a positive electrode tab 71 and a negative electrode tab 72 illustrated in FIG. 3, the electrode tabs 70/71/72 forming an electric path for inducing the current formed in the electrode assembly 40 to the outside.

The rechargeable lithium battery according to some example embodiments may be applicable to, e.g., automobiles, mobile phones, and/or various types of electrical devices, but the present disclosure is not limited thereto.

FIG. 5 is a flow chart illustrating a method of preparing carboxymethyl cellulose lithium salt, according to example embodiments. In FIG. 5, the method 500 includes operation 510, which includes reacting carboxymethyl cellulose sodium salt and sulfuric acid to produce carboxymethyl cellulose. Operation 520 includes reacting the carboxymethyl cellulose and lithium hydroxide to produce carboxymethyl cellulose lithium salt. For example, during the production of the carboxymethyl cellulose, about 50 to about 200 parts by weight of the sulfuric acid is reacted based on 100 parts by weight of the carboxymethyl cellulose sodium salt.

In an example, the carboxylmethyl cellulose sodium salt and the carboxylmethyl cellulose lithium salt satisfy Equation 1:0.8<V₂/V₁≤1.2, wherein V₁ is a viscosity of an aqueous solution of carboxymethyl cellulose sodium salt including about 1 wt % of the carboxymethyl cellulose sodium salt at a temperature of about 25° C., and V₂ is a viscosity of an aqueous solution of carboxymethyl cellulose lithium salt containing about 1 wt % of the carboxymethyl cellulose lithium salt at a temperature of about 25° C. In a further example, V₁ is in a range of about 1,000 cps to about 5,000 cps, and V₂ is in a range of about 1,000 cps to about 5,000 cps.

In yet another example, a reaction of the carboxylmethyl cellulose sodium salt and sulfuric acid, and a reaction of the carboxymethyl cellulose and lithium hydroxide, are each carried out at a temperature in a range of about 20° C. to about 30° C. In a further example, when reacting the carboxymethyl cellulose sodium salt and sulfuric acid: about 50 parts to about 200 parts by weight of the sulfuric acid are reacted based on 100 parts by weight of the carboxymethyl cellulose sodium salt.

Hereinafter, examples of the present disclosure and comparative examples are described. These examples, however, are not in any sense to be interpreted as limiting the scope of the disclosure.

### Example 1

### (1) Preparation of Carboxymethyl Cellulose

300 parts by weight of an ethanol aqueous solution including 95 wt % of ethanol and 30 parts by weight of a carboxylmethyl cellulose sodium salt (Na-CMC) were mixed, and 30 parts by weight of sulfuric acid was added thereto and then, stirred at 25° C. for 1 hour.

After the stirring, the solution was separated into solid and liquid by using a paper filter to obtain carboxylmethyl cellulose (H-CMC). The H-CMC was washed with 600 parts by weight of an ethanol aqueous solution including 80 wt % ethanol. The washing was 5 times in total performed.

### (2) Preparation of Carboxymethyl Cellulose Lithium Salt

30 parts by weight of the carboxylmethyl cellulose (H-CMC) was mixed with 600 parts by weight of an ethanol aqueous solution including 95 wt % of ethanol, and 6.6 parts by weight of LiOH. H₂O was added thereto, and then stirred at 25° C. for 2 hours.

After the stirring, the solution was neutralized to pH 7 by adding acetic acid thereto, and then separated into solid and liquid to obtain a carboxylmethyl cellulose lithium salt (Li-CMC). The Li-CMC was washed with 600 parts by weight of an ethanol aqueous solution including 80 wt % of ethanol and then, dried at 80° C. in an oven.

### Example 2

A carboxylmethyl cellulose lithium salt was prepared in the same manner as in Example 1, with a difference that 15 parts by weight of sulfuric acid was used to prepare the carboxylmethyl cellulose.

### Example 3

A carboxylmethyl cellulose lithium salt was prepared in the same manner as in Example 1, with a difference that 60 parts by weight of sulfuric acid was used to prepare the carboxylmethyl cellulose.

### Comparative Example 1

A carboxylmethyl cellulose lithium salt was prepared in the same manner as in Example 1, with a difference that 10 parts by weight of sulfuric acid was used to prepare the carboxylmethyl cellulose.

### Comparative Example 2

A carboxylmethyl cellulose lithium salt was prepared in the same manner as in Example 1, with a difference that 65 parts by weight of sulfuric acid was used to prepare the carboxylmethyl cellulose.

### Comparative Example 3

In preparing the carboxylmethyl cellulose, 28 parts by weight of hydrochloric acid was used instead of 30 parts by weight of sulfuric acid. Except for this, a carboxylmethyl cellulose lithium salt was prepared in the same manner as in Example 1.

### Evaluation Example 1: Viscosities of Starting and Final Materials

For the examples and the comparative examples, the starting material dilution solutions and the final material dilution solutions were measured with respect to a viscosity by using a viscometer.

Each carboxymethyl cellulose sodium salt aqueous solution including 1 wt % of the carboxymethyl cellulose sodium salt (the starting material dilution solution) was measured with respect to a viscosity at 25° C. as V₁; and each carboxymethyl cellulose lithium salt aqueous solution containing 1 wt % of the carboxymethyl cellulose lithium salt (the final material dilution solutions) was measured with respect to a viscosity at 25° C. as V₂. V₁, V₂, and V₂/V₁ are provided in Table 1 below.

TABLE 1

| | Starting | | | | |
|---|---|---|---|---|---|
| | material | Sulfuric acid or | | | |
| | (parts by | hydrochloric acid | V₁ | V₂ | |
| | weight) | (parts by weight) | (cps) | (cps) | V₂/V₁ |
| Example 1 | 30 | 30 | 2,930 | 2,850 | 0.97 |
| Example2 | 30 | 15 | 2,930 | 2,790 | 0.95 |
| Example3 | 30 | 60 | 2,930 | 2,770 | 0.94 |
| Comparative | 30 | 10 | 2,930 | 1,120 | 0.38 |
| Example1 | | | | | |
| Comparative | 30 | 65 | 2,930 | 2,350 | 0.80 |
| Example2 | | | | | |
| Comparative | 30 | 28 | 2,930 | 780 | 0.27 |
| Example3 | | | | | |

### Evaluation Example 2: Properties of Carboxymethyl Cellulose Lithium Salt

### (1) Number of Microgels

Each carboxylmethyl cellulose lithium salt according to the example and the comparative examples was measured with respect to the number of microgels, and the results are shown in Table 2 below. Herein, the number of microgels is equally defined and measured as described above.

### (2) Degree of Lithium Substitution

Each carboxylmethyl cellulose lithium salt according to the examples and the comparative examples was measured with respect to a lithium substitution degree, and the results are shown in Table 2 below. Herein, the lithium substitution degree is equally defined and measured as described above.

TABLE 2

| | | Sulfuric acid | | |
|---|---|---|---|---|
| | Starting | or hydrochloric | | |
| | material | acid | Number of | Degree of |
| | (parts by | (parts by | microgels | substitution |
| | weight) | weight) | (ea) | (D.S) |
| Example 1 | 30 | 30 | 15 | 0.97 |
| Example 2 | 30 | 15 | 33 | 0.94 |
| Example 3 | 30 | 60 | 12 | 0.95 |
| Comparative | 30 | 10 | 100 or more | 0.61 |
| Example 1 | | | | |
| Comparative | 30 | 65 | 13 | 0.96 |
| Example 2 | | | | |
| Comparative | 30 | 28 | 100 or more | 0.55 |
| Example 3 | | | | |

### Conclusion

The preparation method of some example embodiments, which was represented by the examples, may prepare a carboxylmethyl cellulose lithium salt having a similar viscosity to the viscosity of a carboxylmethyl cellulose sodium salt, a starting material, in a process of preparing the carboxylmethyl cellulose lithium salt from the carboxylmethyl cellulose sodium salt.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A method for preparing carboxymethyl cellulose lithium salt, the method comprising:
reacting carboxymethyl cellulose sodium salt and sulfuric acid to produce carboxymethyl cellulose, and
reacting the carboxymethyl cellulose and lithium hydroxide to produce carboxymethyl cellulose lithium salt;
wherein, during the production of the carboxymethyl cellulose, about 50 to about 200 parts by weight of the sulfuric acid is reacted based on 100 parts by weight of the carboxymethyl cellulose sodium salt.

2. The method as claimed in claim 1, wherein the carboxylmethyl cellulose sodium salt and the carboxylmethyl cellulose lithium salt satisfy Equation 1:
$$0.8 < {V}_{2} / {V}_{1} \leq 1.2 ; \qquad Equation 1$$
wherein:
V₁ is a viscosity of an aqueous solution of carboxymethyl cellulose sodium salt including about 1 wt % of the carboxymethyl cellulose sodium salt at a temperature of about 25° C.; and
V₂ is a viscosity of an aqueous solution of carboxymethyl cellulose lithium salt containing about 1 wt % of the carboxymethyl cellulose lithium salt at a temperature of about 25° C.

3. The method as claimed in claim 2, wherein:
V₁ is in a range of about 1,000 cps to about 5,000 cps; and
V₂ is in a range of about 1,000 cps to about 5,000 cps.

4. The method as claimed in claim 1, wherein a reaction of the carboxylmethyl cellulose sodium salt and sulfuric acid and a reaction of the carboxymethyl cellulose and lithium hydroxide, are each carried out at a temperature in a range of about 20° C. to about 30° C.

5. The method as claimed in claim 1, wherein when reacting the carboxymethyl cellulose sodium salt and sulfuric acid:
about 50 parts to about 200 parts by weight of the sulfuric acid are reacted based on 100 parts by weight of the carboxymethyl cellulose sodium salt.

6. A carboxylmethyl cellulose lithium salt prepared by the method as claimed in claim 1.

7. The carboxylmethyl cellulose lithium salt as claimed in claim 6, wherein:
the number of microgels in a film including the carboxymethyl cellulose lithium salt is one of equal to about 0, and greater than about 0 and less than or equal to about 50;
the microgel being a gel-like substance comprising carboxymethyl cellulose lithium salt and having a substantially spherical shape.

8. The carboxylmethyl cellulose lithium salt as claimed in claim 6, wherein the carboxylmethyl cellulose lithium salt has a degree of lithium substitution in a range of about 0.7 to about 1.3.

9. A negative electrode for a rechargeable lithium battery, the negative electrode comprising:
a current collector; and
a negative electrode active material layer on the current collector;
wherein the negative electrode active material layer comprises the carboxylmethyl cellulose lithium salt as claimed in claim 6.

10. The negative electrode as claimed in claim 9, wherein the carboxylmethyl cellulose lithium salt is included in an amount in a range of about 0.5 wt % to about 3 wt % based on 100 wt % of the total negative electrode active material layer.

11. A rechargeable lithium battery, comprising
the negative electrode as claimed in claim 9;
a positive electrode; and
an electrolyte.
